(19) United States
(12) Patent Application Publication
(10) Pub. No.: US 2021/0349775 A1
(43) Pub. Date: Nov. 11, 2021

(54) METHOD OF DATA MANAGEMENT AND METHOD OF DATA ANALYSIS

(71) Applicant: Jabil Circuit (Shanghai) Co., Ltd., Shanghai (CN)

(72) Inventors: Cheng-Huang Wang, Kaohsiung City (TW); Chin Liang, New Taipei (TW); Shuo-Hung Hsu, New Taipei (TW)

(73) Assignee: Jabil Circuit (Shanghai) Co., Ltd., Shanghai, SH (CN)

(21) Appl. No.: 17/307,539

(22) Filed: May 4, 2021

(30) Foreign Application Priority Data
May 7, 2020 (CN) 202010376791.3

(51) Int. Cl. G06F 11/07; G06F 9/4401

(52) U.S. Cl. CPC G06F 11/0787; G06F 9/4401; G06F 11/0781; G06F 11/0793

(57) ABSTRACT

A method of data management is to be implemented by a baseboard management controller (BMC) of a server. The method includes: collecting normal (abnormal) operation information that is related to current statuses of hardware and firmware components; selecting a portion of the normal (abnormal) operation information; classifying each piece of data included in the portion of the normal (abnormal) operation information as a hardware class or a firmware class; and storing the portion of the normal (abnormal) operation information in the storage.

### CROSS-REFERENCE TO RELATED APPLICATION

This application claims priority of Chinese Invention Patent Application No. 202010376791.3, filed on May 7, 2020.

### TECHNICAL FIELD

The disclosure relates to a method of data management and a method of data analysis, and more particularly to a method of data management and a method of data analysis for facilitating troubleshooting.

### BACKGROUND

A server in a data center includes numerous firmware components, and numerous hardware components including, for example, a central processing unit (CPU), a chipset, and peripheral component interconnect (PCI) devices. Variety of firmware and hardware components in the server increases architecture complexity, and places a heavy burden on a troubleshooter when the server has a problem. Therefore, a way to enhance efficiency of troubleshooting is demanded.

### SUMMARY

Therefore, an object of the disclosure is to provide a method of data management and a method of data analysis that can facilitate troubleshooting of a server.

According to one aspect of the disclosure, the method of data management is to be implemented by a baseboard management controller (BMC) of a server. The server further includes a storage, a plurality of hardware components and a plurality of firmware components. The method includes steps of:

collecting normal operation information that is related to current statuses of the hardware components and the firmware components when the server is in a normal condition and that includes plural pieces of data;

selecting, based on a preset criterion, a portion of the normal operation information thus collected;

classifying each piece of data included in the portion of the normal operation information as one of a hardware class and a firmware class;

storing, in the storage, the portion of the normal operation information the pieces of data of which have thus been classified; and

when the server is in an abnormal condition,

collecting abnormal operation information that is related to current statuses of the hardware components and the firmware components when the server is in the abnormal condition and that includes plural pieces of data,

selecting, based on the preset criterion, a portion of the abnormal operation information thus collected,

classifying each piece of data included in the portion of the abnormal operation information as one of the hardware class and the firmware class, and

storing, in the storage, the portion of the abnormal operation information the pieces of data of which have thus been classified.

According to another aspect of the disclosure, the method of data analysis is to be implemented by a server and a computer. The server includes a baseboard management controller (BMC), a storage, a plurality of hardware components and a plurality of firmware components. The method includes steps of:

collecting, by the BMC, normal operation information that is related to current statuses of the hardware components and the firmware components when the server is in a normal condition and that includes plural pieces of data;

selecting, by the BMC, a portion of the normal operation information thus collected based on a preset criterion;

classifying, by the BMC, each piece of data included in the portion of the normal operation information as one of a hardware class and a firmware class;

storing, by the BMC, the portion of the normal operation information the pieces of data of which have thus been classified in the storage as error log collection (ELC) information for the normal condition;

when the server is in an abnormal condition,

collecting, by the BMC, abnormal operation information that is related to current statuses of the hardware components and the firmware components when the server is in the abnormal condition and that includes plural pieces of data,

selecting, by the BMC, a portion of the abnormal operation information thus collected based on the preset criterion,

classifying, by the BMC, each piece of data included in the portion of the abnormal operation information as one of the hardware class and the firmware class, and

storing, by the BMC, the portion of the abnormal operation information thus classified in the storage as ELC information for the abnormal condition;

reading, by the computer, the ELC information for the normal condition and the ELC information for the abnormal condition from the storage of the server;

comparing, by the computer, the ELC information for the normal condition with the ELC information for the abnormal condition thus read; and

marking, by the computer, each difference between the ELC information for the normal condition and the ELC information for the abnormal condition according to a result of the comparison.

According to still another aspect of the disclosure, the method of data analysis is to be implemented by a server and a computer. The server includes a baseboard management controller (BMC), a storage, a plurality of hardware components and a plurality of firmware components. The method includes steps of:

by the BMC, storing error log collection (ELC) information for a normal condition of the server, where the hardware components and the firmware components work normally, in the storage according to classification of each piece of data included in the ELC information for the normal condition, each piece of data included in the ELC information for the normal condition being classified as one of a hardware class and a firmware class, the ELC information for the normal condition including one of normal operation information related to current statuses of the hardware components and the firmware components when the server is in the normal condition, normal configuration information related to a current configuration of the server in the normal condition, and normal log information related to execution logs of the hardware components and the firmware components when the server is in the normal condition;

by the BMC, storing ELC information for an abnormal condition, where the server operates abnormally, in the storage according to classification of each piece of data included in the ELC information for the abnormal condition, each piece of data included in the ELC information for the abnormal condition being classified as one of the hardware class and the firmware class, the ELC information for the abnormal condition including one of abnormal operation information related to current statuses of the hardware components and the firmware components when the server is in the abnormal condition, abnormal configuration information related to a current configuration of the server in the abnormal condition, and abnormal log information related to execution logs of the hardware components and the firmware components when the server is in the abnormal condition; and

by the computer, reading the ELC information for the normal condition and the ELC information for the abnormal condition from the storage of the server, comparing the ELC information for the normal condition with the ELC information for the abnormal condition thus read, and marking each difference between the ELC information for the normal condition and the ELC information for the abnormal condition according to a result of the comparison.

According to further another aspect of the disclosure, the method of data analysis is to be implemented by a server and a computer. The server includes a baseboard management controller (BMC), a storage, a plurality of hardware components and a plurality of firmware components. The method includes steps of:

by the BMC, storing normal operation information that is related to current statuses of the hardware components and the firmware components when the server is in a normal condition in the storage according to classification of each piece of data included in the normal operation information, each piece of data included in the normal operation information being classified as one of a hardware class related to the hardware components and a firmware class related to the firmware components;

by the BMC, storing abnormal operation information that is related to current statuses of the hardware components and the firmware components when the server is in an abnormal condition in the storage according to classification of each piece of data included in the abnormal operation information, each piece of data included in the abnormal operation information being classified as one of the hardware class and the firmware class; and

by the computer, reading the normal operation information and the abnormal operation information from the storage of the server, and determining whether there is a difference between the normal operation information and the abnormal operation information thus read by comparing the normal operation information with the abnormal operation information.

### BRIEF DESCRIPTION OF THE DRAWINGS

Other features and advantages of the disclosure will become apparent in the following detailed description of the embodiment with reference to the accompanying drawings, of which:

FIG. 1 is a schematic diagram illustrating a system that implements a method of data management and a method of data analysis according to an embodiment of the disclosure;

FIG. 2 is a flow chart illustrating an embodiment of the method of data management according to the disclosure;

FIG. 3 is a flow chart illustrating an embodiment of a method of data analysis according to the disclosure; and

FIG. 4 is a schematic diagram illustrating classification of data by implementing the method of data management according to an embodiment of the disclosure.

### DETAILED DESCRIPTION

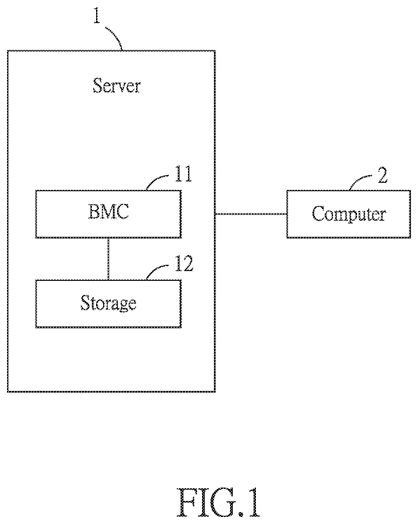

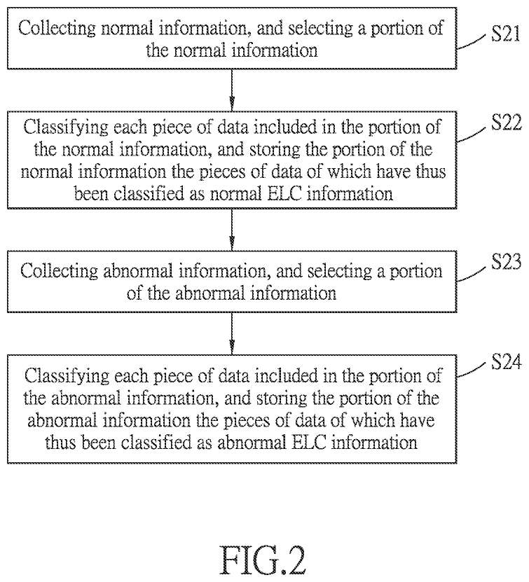

Referring to FIGS. 1 and 2, an embodiment of a method of data management according to the disclosure is to be implemented by a system shown in FIG. 1. The system includes a server 1 and a computer 2. The server 1 includes a baseboard management controller (BMC) 11, a plurality of hardware components (not shown), a plurality of firmware components (not shown), and a storage 12 that corresponds to the BMC 11.

The server 1 may be implemented to be a computing server or a data server in a data center, but implementation of the server 1 is not limited to the disclosure herein and may vary in other embodiments.

The storage 12 is electrically connected to the BMC 11 and is accessible by the BMC 11. The storage 12 may be implemented by flash memory, a hard disk drive (HDD), a solid state disk (SSD), electrically-erasable programmable read-only memory (EEPROM) or any other non-volatile memory devices, but is not limited thereto.

The hardware components may be implemented to be a chipset, and various components electrically connected to the chipset (e.g., a SATA device compatible with the Serial Advanced Technology Attachment (SATA) interface, a USB device meeting the standard of Universal Serial Bus (USB), a real time clock (RTC), an LPC device compatible with the Low Pin Count (LPC) bus, an eSPI device meeting the specification of the Enhanced Serial Peripheral Interface (eSPI), a PCIe device meeting the standard of Peripheral Component Interconnect Express (PCIe), a network controller, a SMBus device compatible with the System Management Bus (SMBus), a power management controller (PMC), an HECI device compatible with the Host Embedded Controller Interface (HECI) bus, etc.). The hardware components may be also implemented to be a central processing unit (CPU), and various components electrically connected to the CPU (e.g., a PCIe device, a DMI device compatible with the Direct Media Interface (DMI), a CHA device supporting Caching and Home Agent (CHA), an integrated memory controller (IMC), a power control unit (PCU), a model-specific register (MSR), etc.).

Each of the firmware components may be implemented to be firmware meeting the specification of Unified Extensible Firmware Interface (UEFI) (hereinafter referred to as “UEFI firmware”) or firmware of the BMC (hereinafter referred to as “BMC firmware”).

The computer 2 may be implemented to be a desktop computer, a laptop computer, a notebook computer or a tablet computer, but implementation thereof is not limited to what are disclosed herein and may vary in other embodiments.

The method of data management includes steps S21 to S24 delineated below. In particular, steps S21 and S22 are executed when the server 1 is in a normal condition, and steps S23 and S24 are executed when the server 1 is in an abnormal condition. It should be noted that it may be possible for steps S23 and S24 to not be executed immediately after steps S21 and S22, which means they may be executed before steps S21 and S22.

In step S21, the BMC 11 collects normal operation information, normal configuration information and normal log information. The normal operation information is related to current statuses of the hardware components and the firmware components when the server 1 is in the normal condition and includes plural pieces of data. The normal configuration information is related to a current configuration of the server 1 in the normal condition and includes plural pieces of data. The normal log information is related to execution logs of the hardware components and the firmware components when the server 1 is in the normal condition and includes plural pieces of data. In addition, the BMC 11 selects, based on a preset criterion, a portion of the normal operation information, a portion of the normal configuration information and a portion of the normal log information thus collected.

For example, in a scenario where only a specific SATA device is to be inspected, the preset criterion is to select a piece of data of the normal operation information that is related to enablement of a particular port of the specific SATA device, a piece of data of the normal configuration information that is related to existence of the specific SATA device, and a piece of data of the normal log information that is related to revision history of the specific SATA device.

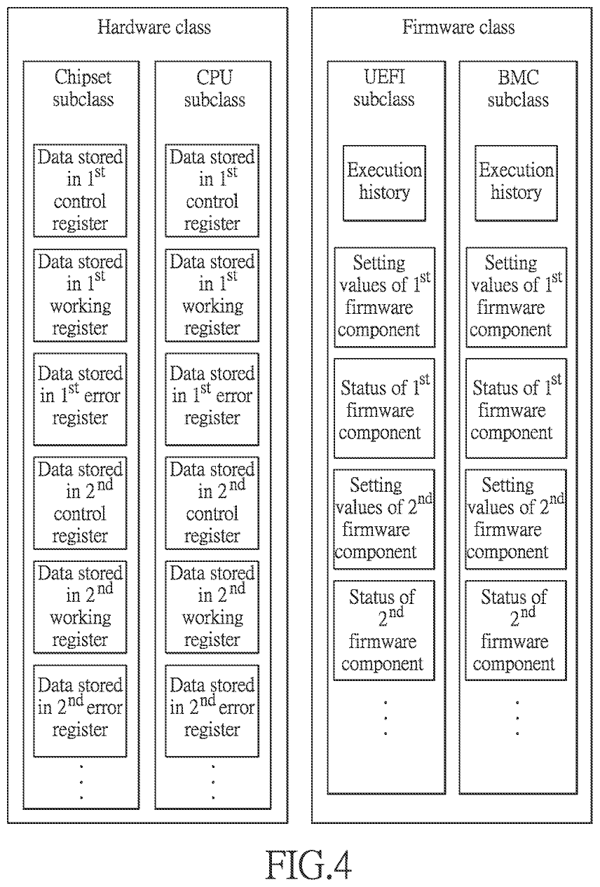

In step S22, as shown in FIG. 4, the BMC 11 classifies each piece of data included in the portion of the normal operation information, the portion of the normal configuration information and the portion of the normal log information as one of a hardware class and a firmware class. Moreover, the BMC 11 further classifies each piece of data that has been classified as the hardware class as one of a chipset subclass and a central processing unit (CPU) subclass, and further classifies each piece of data that has been classified as the firmware class as one of a unified extensible firmware interface (UEFI) subclass and a BMC subclass.

Furthermore, the BMC 11 stores the information thus processed in this step (namely the portion of the normal operation information, the portion of the normal configuration information and the portion of the normal log information the pieces of data of which have been classified) in the storage 12 as error log collection (ELC) information for the normal condition (hereinafter referred to as “normal ELC information”). More specifically, these pieces of data are stored in one of a first manner and a second manner. In the first manner, each piece of data that has been classified as the hardware class is recorded in a first file, each piece of data that has been classified as the firmware class is recorded in a second file, and the first and second files are stored in the storage 12. In the second manner, each piece of data that has been classified as the hardware class is recorded in a first segment of a single file, each piece of data that has been classified as the firmware class is recorded in a second segment of the single file, and the single file is stored in the storage 12.

In step S23, the BMC 11 collects abnormal operation information, abnormal configuration information and abnormal log information. The abnormal operation information is related to current statuses of the hardware components and the firmware components when the server 1 is in the abnormal condition and includes plural pieces of data. The abnormal configuration information is related to a current configuration of the server 1 in the abnormal condition and includes plural pieces of data. The abnormal log information is related to execution logs of the hardware components and the firmware components when the server 1 is in the abnormal condition and includes plural pieces of data. In addition, the BMC 11 selects, based on the preset criterion that is used in step S21, a portion of the abnormal operation information, a portion of the abnormal configuration information and a portion of the abnormal log information thus collected.

In step S24, the BMC 11 classifies each piece of data included in the portion of the abnormal operation information, the portion of the abnormal configuration information and the portion of the abnormal log information as one of the hardware class and the firmware class. Moreover, the BMC 11 further classifies each piece of data that has been classified as the hardware class as one of the chipset subclass and the CPU subclass, and further classifies each piece of data that has been classified as the firmware class as one of the UEFI subclass and the BMC subclass.

Furthermore, the BMC 11 stores the information thus processed in this step (namely the portion of the abnormal operation information, the portion of the abnormal configuration information and the portion of the abnormal log information the pieces of data of which have been classified) in the storage 12 as ELC information for the abnormal condition (hereinafter referred to as “abnormal ELC information”). Similarly, these pieces of data are stored in one of the first manner and the second manner as previously described in step S22.

It is worth to note that each of the normal configuration information and the abnormal configuration information contains current setting values of the firmware components, and data stored in control registers of the hardware components. Each of the normal operation information and the abnormal operation information contains data related to the current statuses of the firmware components, data stored in working registers of the hardware components, and data stored in error registers of the hardware components. Each of the normal log information and the abnormal log information contains execution history of the firmware components (e.g., a record of the booting process), and is generated only by the firmware components based on data related to execution logs, firmware configurations and firmware statuses that are collected by the firmware components. Specifically, each of the normal log information and the abnormal log information includes the data related to execution logs, the firmware configurations and the firmware statuses collected by the firmware components.

FIG. 4 illustrates classification of the pieces of data classified in steps S22 and S24 (i.e., the normal ELC information and the abnormal ELC information). For example, data related to the SATA device, the USB device, the RTC, the LPC device, the eSPI device, the PCIe device, the network controller, the SMBus device, the PMC and the HECI device, which are electrically connected to the chipset, is classified as the chipset subclass of the hardware class.

For the SATA device, the pieces of data of the normal/abnormal configuration information stored in the control registers may include “Port x Enable Bit” of “Port Control” for controlling Port x (x being an ordinal number) of the SATA device, and “AHCI Enable (AE)” and “Host Bus Adapter (HBA) Reset (HR)” of “Global HBA Control”. For the USB device, the pieces of data of the normal/abnormal configuration information stored in the control registers may include “Base Address (BA)”, “Prefetchable”, “Type” and “Resource Type Indicator (RTE)” of “Memory Base Address Register (MBAR)”, and “Enable Wrap Event (EWE)”, “Host Controller Reset (HCRST)” and “Run/Stop (RS)” of “USB Command (USBCMD)”.

For the SATA device, the pieces of data of the normal/abnormal operation information stored in the working registers may include “Port x Present Bit” of “Port Status”, and “Supporting Staggered Spin-up” and “Interface Speed Support (ISS)” of “HBA Capabilities”. For the USB device, the pieces of data of the normal/abnormal operation information stored in the working registers may include “PME_Status” and “PowerState” of “Power Management Control/Status (PM_CS)”, and “Port Change Detect (PCD)” and “Event Interrupt (EINT)” of “USB Status (USBSTS)”.

For the SATA device, the pieces of data of the normal/abnormal operation information stored in the error registers may include “Detected Parity Error (DPE)” and “Signaled System Error (SSE)” of “Device Status (STS)”, and “Diagnostics (DIAG)” and “Error (ERR)” of “Port x Serial ATA Error”. For the USB device, the pieces of data of the normal/abnormal operation information stored in the error registers may include “Master/Target Abort SERR (RMTASERR)” and “Unsupported Request Detected (URD)” of “XHC System Bus Configuration 1 (XHCC1)”, and “Host Controller Error (HCE)” and “Save/Restore Error (SRE)” of “USB Status (USBSTS)”.

For example, data related to the DMI device, the PCIe device, the CHA device, the IMC, the PCU and the MSR, which are electrically connected to the CPU, is classified as the CPU subclass of the hardware class.

For the DMI device, the pieces of data of the normal/abnormal configuration information stored in the control registers may include “AUTO_COMPLETE_PM” and “ABORT_INBOUND_REQUESTS” of “DMI Control Register (DMICTRL)” stored in the DMI control register, and “Virtual Channel x Enable” of “DMI VCx Resource Control” for controlling resource associated with DMI Virtual Channel x (x being an ordinal number) of the DMI device. For the PCIe device, the pieces of data of the normal/abnormal configuration information stored in the control registers may include “I/O Base Address Bits (IOBA)” of “I/O Base (IOBASE)”, and “Maximum Payload Size (MPS)”, “Fatal Error Reporting Enable (FERE)”, “Non-Fatal Error Reporting Enable (NFERE)” and “Correctable Error Reporting Enable (CERE)” of “Device Control (DEVCTL)”.

For the DMI device, the pieces of data of the normal/abnormal operation information stored in the working registers may include “RECEIVED_CPU _RESET_DONE _ACK” of “DMI Status Register (DMISTS)”, and “VCxNP (process of Flow Control initialization)” of “DMI VCx Resource Status”. For the PCIe device, the pieces of data of the normal/abnormal configuration information stored in the working registers may include “Memory Base (MB)” of “Memory Base (MEMBASE) Register”, and “Presence Detect State (PDS)”, “Command Completed (CCS)” and “Presence Detect Changed (PDCS)” of “Slot Status (SLOTSTS)”.

For the DMI device, the pieces of data of the normal/abnormal operation information stored in the error registers may include “FATAL ERROR RECEIVED”, “NON FATAL ERROR RECEIVED” and “CORRECTABLE ERROR RECEIVED” of “Root Port Error Status”. For the PCIe device, the pieces of data of the normal/abnormal operation information stored in the error registers may include “FATAL ERROR RECEIVED”, “NON FATAL ERROR RECEIVED” and “CORRECTABLE ERROR RECEIVED” of “Root Port Error Status”, and “Correctable Error Detected (CED)”, “Non-Fatal Error Detected (NFED)” and “Fatal Error Detected (FED)” of “Device Status (DEVSTS)”.

For example, data related to the UEFI firmware (e.g., “SMBIOS (System Management BIOS)”, “System Configuration (Variable)”, “System Reset Log” and “Inventory”) is classified as the UEFI subclass of the firmware class.

For the normal/abnormal configuration information related to the UEFI firmware, the setting values of the UEFI firmware may include: Typex Information of “SMBIOS”; system configuration variables of the system; setting values of the configuration of platform controller hub; “Memory”; “PCIe”; “Reset Type and Timestamp” of “System Reset Log”, wherein “Reset Type and Timestamp” is for indicating type(s) of timestamp(s) of reset event(s), and “System Reset Log” records reset event(s) of the system; and under “Inventory”, “Memory Slot Mapout” for disabling memory inserted in a platform slot such that the memory is unrecognizable by the system, “CPU Core Disable” for disabling specific core(s) of a CPU, “Storage Enable” for disabling an installed storage device, and “PCIe Slot Disabled”.

For the normal/abnormal operation information related to the UEFI firmware, the status of the UEFI firmware may include topological data of the memory, “CPU Information”, topological data of PCIe, topological data of storage and topological data of network device of “Inventory”.

For the normal/abnormal log information related to the UEFI firmware, the execution history of the UEFI firmware may include “SMBIOS Table Log” of “SMBIOS”, “Debug Message” of “System Configuration”, and “Debug Message” of “Inventory”.

For example, data related to the BMC firmware (e.g., “SDR (Sensor Data Record)”, “Temperature”, “LED Status” and “Power Information”) is classified as the BMC subclass of the firmware class.

For the normal/abnormal configuration information related to the BMC firmware, the setting values of the BMC firmware may include “Temperature Limit” and “Alarm Setting” of “Temperature”.

For the normal/abnormal operation information related to the BMC firmware, the status of the BMC firmware may include “Fan”, “CPU”, “DIMM” and “PSU” of “SDR”, “CPU”, “PCH”, “Fan RPM” and “DIMM” of “Temperature”, “Error or warning LED Status” of “LED status”, and “P12V_AUX”, “P3V3” and “P1V5” of “Power Information”.

For the normal/abnormal log information related to the BMC firmware, the execution history of the BMC firmware may include “System Error Log (SEL)”, “BMC System Log” and “BMC Debug Message”.

Consequently, when an error occurs in the server 1, a technician is able to utilize the normal ELC information and the abnormal ELC information stored in the storage 12 to efficiently analyze the error, find the cause of the error and solve the error.

In one embodiment, the BMC 11 may only collect the normal configuration information and the abnormal configuration information, or only collect the normal operation information and the abnormal operation information, or only collect the normal log information and the abnormal log information.

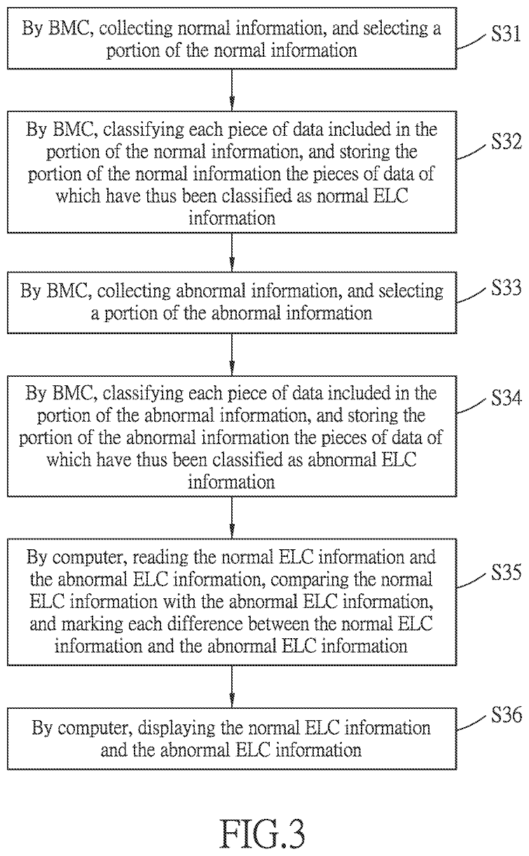

Referring to FIG. 3, an embodiment of a method of data analysis according to the disclosure is illustrated. The method of data analysis is similar to the method of data management, and includes steps S31 to S36, in which steps S31 to S34 are similar respectively to steps S21 to S24 of the method of data management (see FIG. 2), so only steps S35 and S36 are delineated below.

In step S35, the computer 2 reads the normal ELC information and the abnormal ELC information from the storage 12 of the server 1, and compares the normal ELC information with the abnormal ELC information thus read. Additionally, the computer 2 marks each difference between the normal ELC information and the abnormal ELC information according to a result of the comparison.

It should be noted that in one embodiment where the server 1 is still operational when the server 1 is in the abnormal condition, a processing unit (e.g., the CPU) of the server 1 reads the normal ELC information and the abnormal ELC information from the storage 12 of the server 1, compares the normal ELC information with the abnormal ELC information thus read, and marks each difference between the normal ELC information and the abnormal ELC information according to a result of the comparison.

In step S36, the computer 2 displays the normal ELC information and the abnormal ELC information on a display device (e.g., a computer monitor) thereof. At the same time, each difference between the normal ELC information and the abnormal ELC information thus marked is also displayed on the display device.

In one embodiment, the computer 2 reads the normal operation information and the abnormal operation information from the storage 12 of the server 1, and determines whether there is a difference between the normal operation information and the abnormal operation information thus read by comparing the normal operation information with the abnormal operation information.

In summary, in the methods according to the disclosure, the BMC 11 of the server 1 collects the normal/abnormal operation information that is related to the current statuses of the hardware and firmware components when the server 1 is in the normal/abnormal condition, the normal/abnormal configuration information that is related to the current configuration of the server 1 when the server 1 is in the normal/abnormal condition, and the normal/abnormal log information that is related to the execution logs of the hardware components and the firmware components when the server 1 is in the normal/abnormal condition. Then, the BMC 11 selects a portion of the normal/abnormal operation information, a portion of the normal/abnormal configuration information, and a portion of the normal/abnormal log information. Next, the BMC 11 performs classification of data on the portion of the normal/abnormal operation information, the portion of the normal/abnormal configuration information and the portion of the normal/abnormal log information. Subsequently, the BMC 11 stores, in the storage in a manner that depends on a result of the classification, the portions of information that have undergone classification of data as the normal/abnormal ELC information. The normal and abnormal ELC information may facilitate trouble shooting when the server 1 is in the abnormal condition.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method of data management to be implemented by a baseboard management controller (BMC) of a server, the server further including a storage, a plurality of hardware components and a plurality of firmware components, the method comprising steps of:
collecting normal operation information that is related to current statuses of the hardware components and the firmware components when the server is in a normal condition and that includes plural pieces of data;
selecting, based on a preset criterion, a portion of the normal operation information thus collected;
classifying each piece of data included in the portion of the normal operation information as one of a hardware class and a firmware class;
storing, in the storage, the portion of the normal operation information the pieces of data of which have thus been classified; and
when the server is in an abnormal condition,
collecting abnormal operation information that is related to current statuses of the hardware components and the firmware components when the server is in the abnormal condition and that includes plural pieces of data,
selecting, based on the preset criterion, a portion of the abnormal operation information the pieces of data of which have thus been collected,
classifying each piece of data included in the portion of the abnormal operation information as one of the hardware class and the firmware class, and
storing, in the storage, the portion of the abnormal operation information the pieces of data of which have thus been classified.

2. The method as claimed in claim 1, further comprising steps of:
collecting normal configuration information that is related to a current configuration of the server in the normal condition and that includes plural pieces of data, and normal log information that is related to execution logs of the hardware components and the firmware components when the server is in the normal condition and that includes plural pieces of data;
selecting, based on the preset criterion, a portion of the normal configuration information and a portion of the normal log information;
classifying each piece of data included in the portion of the normal configuration information and the portion of the normal log information as one of the hardware class and the firmware class;
storing, in the storage, the portion of the normal configuration information and the portion of the normal log information the pieces of data of which have thus been classified; and
when the server is in the abnormal condition,
collecting abnormal configuration information that is related to a current configuration of the server in the abnormal condition and that includes plural pieces of data, and abnormal log information that is related to execution logs of the hardware components and the firmware components when the server is in the abnormal condition and that includes plural pieces of data,
selecting, based on the preset criterion, a portion of the abnormal configuration information and a portion of the abnormal log information,
classifying each piece of data included the portion of the abnormal configuration information and the portion of the abnormal log information as one of the hardware class and the firmware class, and
storing, in the storage, the portion of the abnormal configuration information and the portion of the abnormal log information the pieces of data of which have thus been classified.

3. The method as claimed in claim 2, wherein:
each of the normal configuration information and the abnormal configuration information contains current setting values of the firmware components, and data stored in control registers of the hardware components;
each of the normal operation information and the abnormal operation information contains data related to status of the firmware components, data stored in working registers of the hardware components, and data stored in error registers of the hardware components; and
each of the normal log information and the abnormal log information contains execution history of the firmware components, and is generated only by the firmware components based on data related to execution logs, firmware configurations and firmware statuses that are collected by the firmware components.

4. The method as claimed in claim 2, wherein, in the step of storing the portion of the normal operation information, the step of storing the portion of the abnormal operation information, the step of storing the portion of the normal configuration information and the portion of the normal log information, and the step of storing the portion of the abnormal configuration information and the portion of the abnormal log information, the pieces of data are stored in one of:
a first manner that each piece of data that has been classified as the hardware class is recorded in a first file, each piece of data that has been classified as the firmware class is recorded in a second file, and the first and second files are stored in the storage; and
a second manner that each piece of data that has been classified as the hardware class is recorded in a first segment of a single file, each piece of data that has been classified as the firmware class is recorded in a second segment of the single file, and the single file is stored in the storage.

5. The method as claimed in claim 2, wherein, in the step of classifying each piece of data included in the portion of the normal operation information, the step of classifying each piece of data included in the portion of the abnormal operation information, the step of classifying each piece of data included in the portion of the normal configuration information and each piece of data included in the portion of the normal log information, and the step of classifying each piece of data included in the portion of the abnormal configuration information and each piece of data included in the portion of the abnormal log information, each piece of data is classified by:
classifying the piece of data as one of the hardware class and the firmware class;
further classifying the piece of data as one of a chipset subclass and a central processing unit (CPU) subclass when the piece of data has been classified as the hardware class; and
further classifying the piece of data as one of a unified extensible firmware interface (UEFI) subclass and a BMC subclass when the piece of data has been classified as the firmware class.

6. The method as claimed in claim 1, wherein in the step of storing the portion of the normal operation information and the step of storing the portion of the abnormal operation information, the pieces of data of the portion of the normal operation information or the portion of the abnormal operation information are stored in one of:
a first manner that each piece of data that has been classified as the hardware class is recorded in a first file, each piece of data that has been classified as the firmware class is recorded in a second file, and the first and second files are stored in the storage; and
a second manner that each piece of data that has been classified as the hardware class is recorded in a first segment of a single file, each piece of data that has been classified as the firmware class is recorded in a second segment of the single file, and the single file is stored in the storage.

7. The method as claimed in claim 1, wherein:
the step of classifying each piece of data included in the portion of the normal operation information includes
classifying each piece of data included in the portion of the normal operation information as one of the hardware class and the firmware class,
further classifying any piece of data included in the portion of the normal operation information that has been classified as the hardware class as one of a chipset subclass and a central processing unit (CPU) subclass, and
further classifying any piece of data included in the portion of the normal operation information that has been classified as the firmware class as one of a unified extensible firmware interface (UEFI) subclass and a BMC subclass; and
the step of classifying each piece of data included in the portion of the abnormal operation information includes
classifying each piece of data included in the portion of the abnormal operation information as one of the hardware class and the firmware class,
further classifying any piece of data included in the portion of the abnormal operation information that has been classified as the hardware class as one of the chipset subclass and the CPU subclass, and
further classifying any piece of data included in the portion of the abnormal operation information that has been classified as the firmware class as one of the UEFI subclass and the BMC subclass.

8. A method of data analysis to be implemented by a server and a computer, the server including a baseboard management controller (BMC), a storage, a plurality of hardware components and a plurality of firmware components, the method comprising steps of:
collecting, by the BMC, normal operation information that is related to current statuses of the hardware components and the firmware components when the server is in a normal condition and that includes plural pieces of data;
selecting, by the BMC, a portion of the normal operation information thus collected based on a preset criterion;
classifying, by the BMC, each piece of data included in the portion of the normal operation information as one of a hardware class and a firmware class;
storing, by the BMC, the portion of the normal operation information the pieces of data of which have thus been classified in the storage as error log collection (ELC) information for the normal condition;
when the server is in an abnormal condition,
collecting, by the BMC, abnormal operation information that is related to current statuses of the hardware components and the firmware components when the server is in the abnormal condition and that includes plural pieces of data,
selecting, by the BMC, a portion of the abnormal operation information thus collected based on the preset criterion,
classifying, by the BMC, each piece of data included in the portion of the abnormal operation information as one of the hardware class and the firmware class, and
storing, by the BMC, the portion of the abnormal operation information the pieces of data of which have thus been classified in the storage as ELC information for the abnormal condition;
reading, by the computer, the ELC information for the normal condition and the ELC information for the abnormal condition from the storage of the server;
comparing, by the computer, the ELC information for the normal condition with the ELC information for the abnormal condition thus read; and
marking, by the computer, each difference between the ELC information for the normal condition and the ELC information for the abnormal condition according to a result of the comparison.

9. The method as claimed in claim 8, further comprising steps of:
collecting, by the BMC, normal configuration information that is related to a current configuration of the server in the normal condition and that includes plural pieces of data, and normal log information that is related to execution logs of the hardware components and the firmware components when the server is in the normal condition and that includes plural pieces of data;
selecting, by the BMC based on the preset criterion, a portion of the normal configuration information and a portion of the normal log information;
classifying, by the BMC, each piece of data included in the portion of the normal configuration information and the portion of the normal log information as one of the hardware class and the firmware class;
storing, by the BMC, the portion of the normal configuration information and the portion of the normal log information the pieces of data of which have thus been classified in the storage as the ELC information for the normal condition; and
by the BMC when the server is in the abnormal condition,
collecting abnormal configuration information that is related to a current configuration of the server in the abnormal condition and that includes plural pieces of data, and abnormal log information that is related to execution logs of the hardware components and the firmware components when the server is in the abnormal condition and that includes plural pieces of data,
selecting, based on the preset criterion, a portion of the abnormal configuration information and a portion of the abnormal log information,
classifying each piece of data included the portion of the abnormal configuration information and the portion of the abnormal log information as one of the hardware class and the firmware class, and
storing the portion of the abnormal configuration information and the portion of the abnormal log information the pieces of data of which have thus been classified in the storage as the ELC information for the abnormal condition.

10. The method as claimed in claim 9, wherein:
each of the normal configuration information and the abnormal configuration information contains current setting values of the firmware components, and data stored in control registers of the hardware components;
each of the normal operation information and the abnormal operation information contains data related to status of the firmware components, data stored in working registers of the hardware components, and data stored in error registers of the hardware components; and
each of the normal log information and the abnormal log information contains execution history of the firmware components, and is generated only by the firmware components based on data related to execution logs, firmware configurations and firmware statuses that are collected by the firmware components.

11. The method as claimed in claim 9, wherein, in the step of storing the portion of the normal operation information, the step of storing the portion of the abnormal operation information, the step of storing the portion of the normal configuration information and the portion of the normal log information, and the step of storing the portion of the abnormal configuration information and the portion of the abnormal log information, the pieces of data of the portion of the normal operation information, or the portion of the abnormal operation information, or the portions of the normal configuration information and the normal log information, or the portions of the abnormal configuration information and the abnormal log information are stored in one of:
a first manner that each piece of data that has been classified as the hardware class is recorded in a first file, each piece of data that has been classified as the firmware class is recorded in a second file, and the first and second files are stored in the storage; and
a second manner that each piece of data that has been classified as the hardware class is recorded in a first segment of a single file, each piece of data that has been classified as the firmware class is recorded in a second segment of the single file, and the single file is stored in the storage.

12. The method as claimed in claim 9, wherein, in the step of classifying each piece of data included in the portion of the normal operation information, the step of classifying each piece of data included in the portion of the abnormal operation information, the step of classifying each piece of data included in the portion of the normal configuration information and the portion of the normal log information, and the step of classifying each piece of data included in the portion of the abnormal configuration information and the portion of the abnormal log information, each piece of data is classifying by:
classifying the piece of data as one of the hardware class and the firmware class;
further classifying the piece of data as one of a chipset subclass and a central processing unit (CPU) subclass when the piece of data has been classified as the hardware class; and
further classifying the piece of data as one of a unified extensible firmware interface (UEFI) subclass and a BMC subclass when the piece of data has been classified as the firmware class.

13. The method as claimed in claim 8, wherein in the step of storing the portion of the normal operation information and the step of storing the portion of the abnormal operation information, the pieces of data of the portion of the normal operation information or the portion of the abnormal operation information are stored in one of:
a first manner that each piece of data that has been classified as the hardware class is recorded in a first file, each piece of data that has been classified as the firmware class is recorded in a second file, and the first and second files are stored in the storage; and
a second manner that each piece of data that has been classified as the hardware class is recorded in a first segment of a single file, each piece of data that has been classified as the firmware class is recorded in a second segment of the single file, and the single file is stored in the storage.

14. The method as claimed in claim 8, wherein:
the step of classifying each piece of data included in the portion of the normal operation information includes
classifying each piece of data included in the portion of the normal operation information as one of the hardware class and the firmware class,
further classifying any piece of data included in the portion of the normal operation information that has been classified as the hardware class as one of a chipset subclass and a central processing unit (CPU) subclass, and
further classifying any piece of data included in the portion of the normal operation information that has been classified as the firmware class as one of a unified extensible firmware interface (UEFI) subclass and a BMC subclass; and
the step of classifying each piece of data included in the portion of the abnormal operation information includes
classifying each piece of data included in the portion of the abnormal operation information as one of the hardware class and the firmware class,
further classifying any piece of data included in the portion of the abnormal operation information that has been classified as the hardware class as one of the chipset subclass and the CPU subclass, and
further classifying any piece of data included in the portion of the abnormal operation information that has been classified as the firmware class as one of the UEFI subclass and the BMC subclass.

15. A method of data analysis to be implemented by a server and a computer, the server including a baseboard management controller (BMC), a storage, a plurality of hardware components and a plurality of firmware components, the method comprising:
by the BMC, storing error log collection (ELC) information for a normal condition of the server, where the hardware components and the firmware components work normally, in the storage according to classification of each piece of data included in the ELC information for the normal condition, each piece of data included in the ELC information for the normal condition being classified as one of a hardware class and a firmware class, the ELC information for the normal condition including one of normal operation information related to current statuses of the hardware components and the firmware components when the server is in the normal condition, normal configuration information related to a current configuration of the server in the normal condition, and normal log information related to execution logs of the hardware components and the firmware components when the server is in the normal condition;
by the BMC, storing ELC information for an abnormal condition of the server, where the server operates abnormally, in the storage according to classification of each piece of data included in the ELC information for the abnormal condition, each piece of data included in the ELC information for the abnormal condition being classified as one of the hardware class and the firmware class, the ELC information for the abnormal condition including one of abnormal operation information related to current statuses of the hardware components and the firmware components when the server is in the abnormal condition, abnormal configuration information related to a current configuration of the server in the abnormal condition, and abnormal log information related to execution logs of the hardware components and the firmware components when the server is in the abnormal condition; and
by the computer, reading the ELC information for the normal condition and the ELC information for the abnormal condition from the storage of the server, comparing the ELC information for the normal condition with the ELC information for the abnormal condition thus read, and marking each difference between the ELC information for the normal condition and the ELC information for the abnormal condition according to a result of the comparison.
